(19) United States
(12) Patent Application Publication
(10) Pub. No.: US 2025/0267615 A1
(43) Pub. Date: Aug. 21, 2025

(54) METHODS AND NODES FOR FAILURE HANDLING FOR TEG REPORT

(71) Applicant: TELEFONAKTIEBOLAGET LM ERICSSON (PUBL), Stockholm (SE)

(72) Inventors: DEEP SHRESTHA, LINKÖPING (SE); RITESH SHREEVASTAV, STOCKHOLM (SE); YAZID LYAZIDI, LONDON (GB); SIVA MURUGANATHAN, OTTAWA (CA)

(21) Appl. No.: 18/857,349

(22) PCT Filed: Apr. 21, 2023
(86) PCT No.: PCT/IB2023/054125

§ 371 Date: Oct. 16, 2024

Related U.S. Application Data
(60) Provisional application No. 63/333,196, filed on Apr. 21, 2022.

(51) Int. Cl. H04W 64/00

(52) U.S. Cl. CPC H04W 64/00

(57) ABSTRACT

There is provided a method performed by a radio node. The method comprises: receiving a request, from a network node, for timing error group (TEG) information; and in response to a failure to provide the TEG information, sending a message comprising an indication of failure to report the TEG information, to the network node. There is also a method performed by a network node. The method comprises: sending a request to a radio node for timing error group (TEG) information; and receiving, from the radio node, a message comprising an indication of a failure to provide the TEG information.

### RELATED APPLICATIONS

This application claims the benefits of priority of U.S. Provisional Patent Application No. 63/333,196, entitled “Failure Handling for TEG Report” and filed at the United States Patent and Trademark Office on Apr. 21, 2022, the content of which is incorporated herein by reference

### TECHNICAL FIELD

The present disclosure relates to wireless communication systems and more specifically to methods and nodes for failure handling for Time Error Group (TEG) reports.

### BACKGROUND

### New Radio (NR) Positioning Architecture

Since Release (Rel)-15 and the introduction of NR, the Long Term Evolution (LTE) Positioning Protocol (LPP), which is a point-to-point communication protocol between an Location Management Function (LMF) and a target device, has been agreed to be reused for User Equipment (UE) positioning in both NR and Evolved Universal Mobile Telecommunications System (UMTS) Terrestrial Radio Access (E-UTRA), see for example third Generation project partnership (3GPP) Technical Specification (TS) 37.355.

At the core network, a new logical node called the LMF is the main server responsible for computing the UE position, based on the NR, E-UTRA, or both Radio Access Technologies (RATs) specific positioning methods in a hybrid way. NR Positioning Protocol Annex (NRPPa) is the communication protocol between a Next Generation (NG)-Radio Access Network (RAN) and the LMF specified in TS 38.455.

The NR Positioning architecture is defined in FIG. 1, as specified in TS 38.305.

In Rel-16, new and enhanced positioning methods have been defined in NR for helping computing UE positioning, such as:
NR enhanced cell ID (E-CID);
Multi-Round Trip Time (RTT) Positioning;
Downlink Angle-of-Departure (DL-AoD);
Downlink Time Difference of Arrival (DL-TDOA);
Uplink Time Difference of Arrival (UL-TDOA);
Uplink Angle of Arrival (UL-AoA), including the Azimuth of Arrival (A-AoA) and the Zenith of Arrival (Z-AoA).

An example of signalling exchange for UL-TDOA positioning (also applicable for UL-AOA) is illustrated in FIG. 2.

In Rel-16, the Multi-RTT positioning method was specified as part of the “UE performs UE Receive (Rx)-Transmit (Tx) measurements”.

### Mitigation of Timing Errors in Positioning

In Rel-17, the accuracy enhancements for time-based methods (multi-RTT, DL TDOA, UL TDOA) have been proposed to mitigate timing errors, which resulted in the introduction of the timing error group (TEG) concept. The principle stems from the observation that signals transmitted or received on different beams may be carried over different Radio Frequency (RF) chains or different antenna panels. Even after calibration in the UE/Transmission Reception Point (TRP) implementation, there will always be a residual timing error in transmission and reception timing between signals transmitted over these different RF chains/antenna panels.

As a consequence of such residual timing errors (referred to as timing errors henceforth), the UE may not know exactly when a signal, such as the Sounding Reference Signal (SRS) is transmitted from the UE-antenna resulting in an unknown transmit (TX)-delay, τ_{TX} as shown in FIG. 3. Note that τ_{TX} is the remaining error after any compensation performed by the UE for known delays and that τ_{TX} can be positive or negative.

If the UE has only one antenna panel, this TX timing error will cancel when TDOA measurements are formed from gNB (base station) uplink received time of arrival (UL-RTOA) measurements. When the UE has multiple antenna panels, the TX timing error can be different for the different UE antenna panels and as a consequence TX timing errors don't always cancel when forming gNB TDOA measurements as illustrated in FIG. 4. For example, FIG. 4 shows that when the same UE antenna panel is utilized both for the target TRP (e.g. TRP-2) and for the reference TRP, the TX timing errors cancel when the Reference Signal Time Difference (RSTD) is formed (e.g., RSTD₂). However, when different UE antenna panels are utilized for the target TRP (e.g. TRP-1) and for the reference TRP the TX timing errors don't cancel when the RSTD is formed (e.g., RSTD₁).

As results of the Tx timing error differences (i.e., when the Tx timing errors do not cancel as in the case of RSTD₁ in FIG. 4), the accuracy for UL TDOA positioning is reduced

However, if one reference TRP is used for each UE antenna panel when forming RSTD measurements, then the TX timing errors are cancelled as illustrated in FIG. 5. In the figure, TRP-1 is added as reference TRP for antenna panel a, while the standard REF-TRP is maintained as reference TRP for antenna panel b. For example, when forming RSTD measurements in the normal way utilizing only one reference TRP, the TX timing errors don't generally cancel (e.g., RSTD₁ and RSTD₃). However, if one reference TRP is used for each antenna panel when forming RSTD measurements, then the TX timing errors are cancelled. In FIG. 5, TRP-1 is added as reference TRP for antenna panel a while the standard REF-TRP is maintained as reference TRP for antenna panel b, resulting in the two TX timing error free RSTD measurements (e.g., RSTD₂ and RSTD₃-1).

To make it possible for LMF to know which measurements can be combined such that the associated TX/RX timing errors cancel, the TEG concept is introduced in 3GPP NR Rel-17. When the LMF knows which measurements can be grouped using the TEG concept, the TX/RX timing errors can be mitigated and the positioning performance can be greatly improved. Different types of TEGs at both the UE and TRP have been introduced in NR Rel-17. These include the following:
UE Tx ‘timing error group’ (UE Tx TEG): A UE Tx TEG is associated with the transmissions of one or more UL SRS resources for the positioning purpose, which have the Tx timing errors within a certain margin.
TRP Tx ‘timing error group’ (TRP Tx TEG): A TRP Tx TEG is associated with the transmissions of one or more DL PRS resources, which have the Tx timing errors within a certain margin.
UE Rx ‘timing error group’ (UE Rx TEG): A UE Rx TEG is associated with one or more DL measurements, which have the Rx timing errors within a certain margin.
TRP Rx ‘timing error group’ (TRP Rx TEG): A TRP Rx TEG is associated with one or more UL measurements, which have the Rx timing errors within a margin.
TRP RxTx ‘Timing Error Group’ (TRP RxTx TEG): Rx timing errors and Tx timing errors, associated with TRP reporting of one or more gNB Rx-Tx time difference measurements, which have the ‘Rx timing errors+Tx timing errors’ differences within a certain margin.
UE RxTx ‘Timing Error Group’ (UE RxTx TEG): Rx timing errors and Tx timing errors, associated with UE reporting of one or more UE Rx-Tx time difference measurements, which have the ‘Rx timing errors+Tx timing errors’ differences within a certain margin.

FIG. 6 illustrates an example of UL SRS TEG Tx association with SRS Resource sets and SRS Resource.

In NR Rel-17, TEGs can be used to mitigate the impact of UE TX timing errors for UL TDOA/Multi-RTT positioning. In order to achieve this, the UE needs to report the association between SRS (transmitted in SRS resources) and UE Tx TEGs (i.e., associated UE TX TEG IDs).

### Inactive Mode Positioning

3GPP Rel-17 defines a procedure by which a UE can perform positioning in low power state such as Radio Resource Control (RRC) Inactive state. The UE may obtain necessary assistance data in Inactive mode via positioning system information broadcast and perform RSTD measurements in Inactive mode and further also transmit the positioning measurements report to the network (NW) in inactive mode.

Small data transmission (SDT) is a procedure to transmit UL data from the UE in RRC_INACTIVE state. SDT is performed with either random access or configured grant (CG).

Small data solutions have earlier been introduced in LTE with the focus on Machine Type communication (MTC). For example, Rel-15 Early Data Transmission (EDT) and Rel-16 Preconfigured Uplink Resources (PUR) have been standardized for LTE-M and NarrowBand-Internet of Things (NB-IoT). Unlike these features, the Rel-17 Small Data for NR is not directly targeting MTC use cases and the work item description (WID) for small data transmission included smartphone background traffic as the justification.

Sections 5.7.14 and 5.7.15 of TS 38.331 v17.0.0) describe UE positioning information.

### SUMMARY

There currently exist certain challenge(s). To mitigate UE Tx timing errors for UL TDOA or Multi-RTT, the UE sends the TEG association information of UL SRS resources for positioning with Tx TEG IDs to the serving gNB, and the serving gNB should forward the association information provided by the UE to the LMF. Different interfaces are affected: Uu, RRC, F1 and NRPPa. However, the signaling of the association information adds load to the network. The signaling mechanism to send association information of UL SRS resources for positioning with Tx TEGs should be well designed/optimized and further the procedure should be robust enough that the UE can handle and report errors.

Similarly, the LMF can request a TRP to measure the same SRS resource of a UE with different TRP Rx TEGs for UL-TDOA or multiple RxTx TEGs (where RxTx TEGs are as defined in TS 38.214 V17.1.0) for multi-RTT, and report the corresponding measurements to the LMF.

The current standard however does not provide the provision for failure handling for the above reports, hence how to handle failures for the above reports is an open problem.

The above also holds true for UE Rx TEG association with DL-Positioning Reference Signal (PRS).

Certain aspects of the disclosure and their embodiments may provide solutions to these or other challenges.

For example, the disclosure provides a signalling mechanism for signalling any failure messages/information elements (IEs) when a UE is unable to report the UE Tx TEG association with SRS or the TEG IDs.

The disclosure also provides a signalling mechanism for indicating a failure when the LMF requests a TRP to measure the same SRS resource of a UE with different TRP Rx TEGs for UL-TDOA.

The disclosure further provides a signalling mechanism for indicating a failure when the LMF requests a TRP to measure the same SRS resource of a UE with different TRP RxTx for gNB Rx-Tx time difference measurement.

The disclosure further provides a mechanism for the NW to understand if the UE is performing positioning operations in low power state to reduce power consumption and hence it may not be able to provide results which may yield higher power consumption.

More specifically, a method performed by a radio node (e.g. gNB) is provided. The method comprises: receiving a request, from a network node, for timing error group (TEG) information; and in response to a failure to provide the TEG information, sending a message comprising an indication of failure to report the TEG information, to the network node. A radio node for performing this method is also provided.

A method performed by a network node (e.g. LMF) is provided as well. The method comprises: sending a request to a radio node for timing error group (TEG) information; and receiving, from the radio node, a message comprising an indication of a failure to provide the TEG information. The network node for performing this method is also provided.

Certain embodiments may provide one or more of the following technical advantage(s).
Opportunity for the UE to inform the NW that it is unable to provide the UE report.
Opportunity for the gNB-Distributed Unit (DU) to inform the gNB-Central Unit (CU) that it is unable to provide the TRP report.
Opportunity for the gNB-CU to inform the positioning server that it is unable to provide the TRP report.
Opportunity for the NW (LMF) to realize that the UE operates in a low power state and that power saving is critical.

### BRIEF DESCRIPTION OF THE DRAWINGS

Exemplary embodiments will be described in more detail with reference to the following figures, in which:

FIG. 1 illustrates an example of a Positioning architecture in NR.

FIG. 2 illustrates an example of a flow chart for the UL-TDOA method as specified in TS 38.305.

FIG. 3 illustrates an example of a transmit delay resulting from timing errors.

FIG. 4 illustrates an example of different transmit timing errors.

FIG. 5 illustrates an example of RSTD measurements in which some timing errors cancel and some other timing errors don't cancel.

FIG. 6 illustrates an example of UL SRS TEG Tx association with SRS Resource sets and SRS Resource.

FIG. 7 illustrates an example of a sequence flow/signalling diagram for UE Tx TEG association with SRS, according to an embodiment.

FIG. 8 illustrates an example of a sequence flow/signalling diagram between a UE and a LMF for reporting a failure of TEG association with a reference signal, according to an embodiment.

FIG. 9 illustrates an example of a sequence flow/signalling diagram between a gNB and a LMF for reporting a failure of TEG association with a reference signal, according to an embodiment.

FIG. 10 illustrates an example of a Positioning Information Exchange procedure, unsuccessful operation, according to an embodiment.

FIG. 11 illustrates an example of a Positioning Measurement procedure: unsuccessful operation, according to an embodiment.

FIG. 12 illustrates an example of a Positioning Information Exchange procedure, unsuccessful operation, according to an embodiment.

FIG. 13 illustrates an example of a Measurement procedure: Unsuccessful operation, according to an embodiment.

FIG. 14 illustrates an example of a flow chart of a method in a radio node, according to an embodiment.

FIG. 15 illustrates an example of a flow chart of a method in a network node, according to an embodiment.

FIG. 16 shows an example of a communication system, according to an embodiment.

FIG. 17 shows a schematic diagram of a UE, according to an embodiment.

FIG. 18 shows a schematic diagram of a network node, according to an embodiment.

FIG. 19 illustrates a block diagram of a host.

FIG. 20 illustrates a block diagram illustrating a virtualization environment.

FIG. 21 shows a communication diagram of a host.

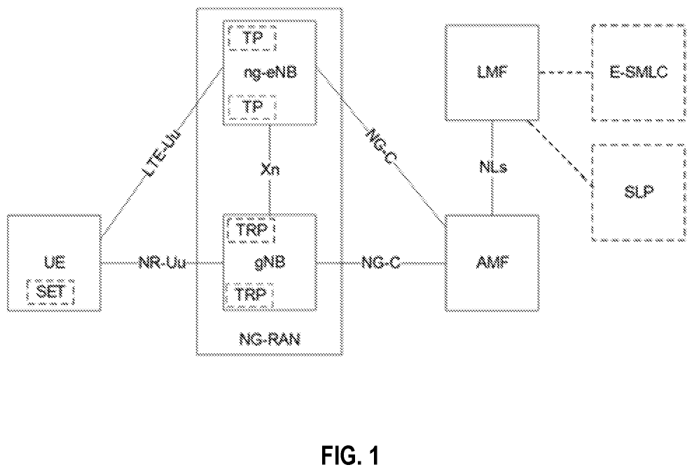

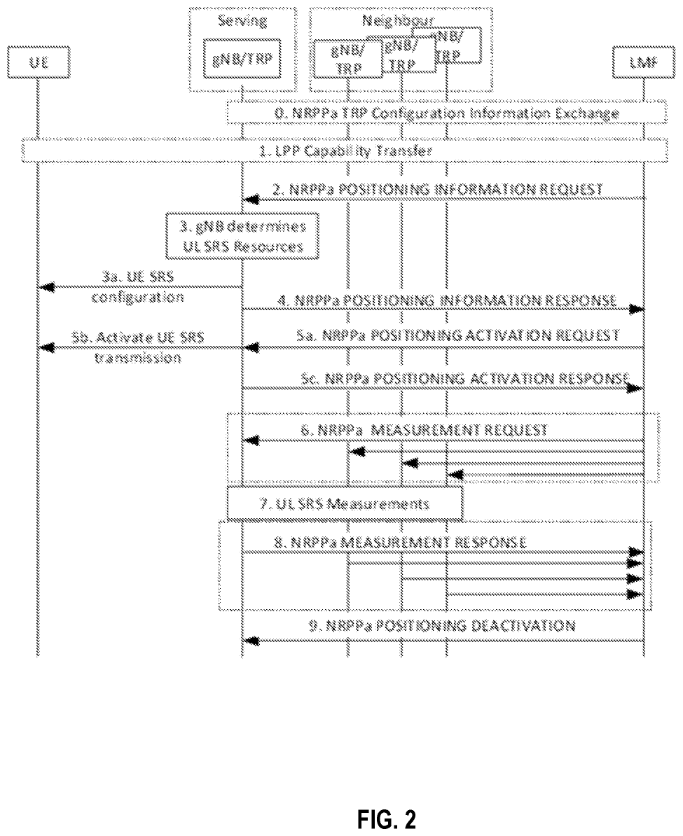

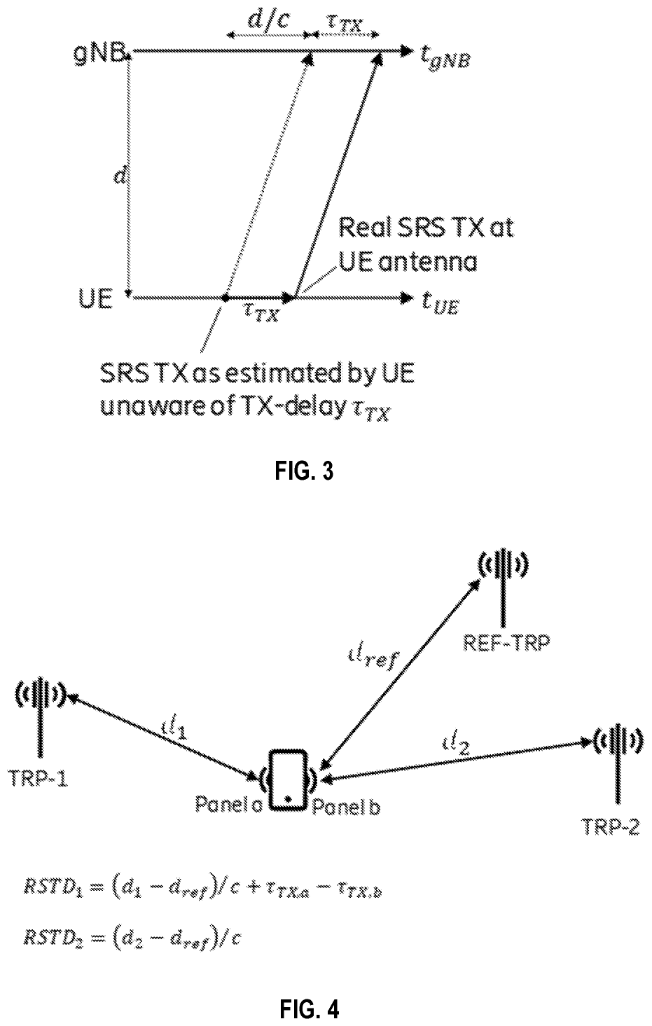

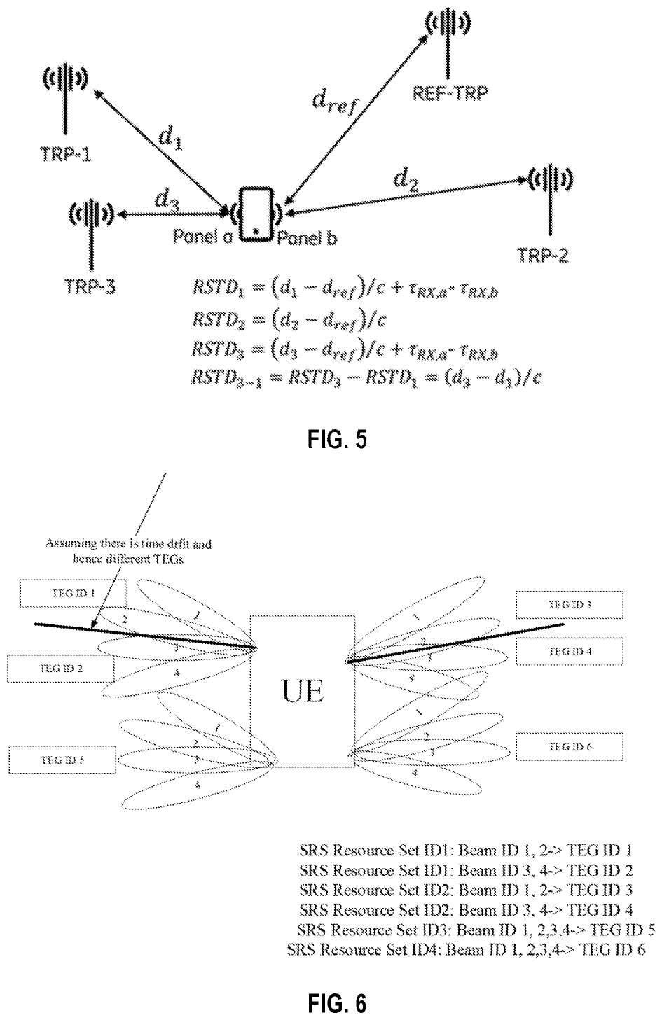

### DETAILED DESCRIPTION

Some of the embodiments contemplated herein will now be described more fully with reference to the accompanying drawings. Embodiments are provided by way of example to convey the scope of the subject matter to those skilled in the art.

Embodiments herein provide a method for defining new IEs (or information) in the signaling for UE Tx TEG association with UL-SRS, where the signaling comprises sending a failure indicator to the NW.

The embodiments also provide a method for defining new IEs (or information) in the signaling for UE Rx TEG association with measurements performed on DL-PRS where the signaling comprises sending a failure indicator to the NW.

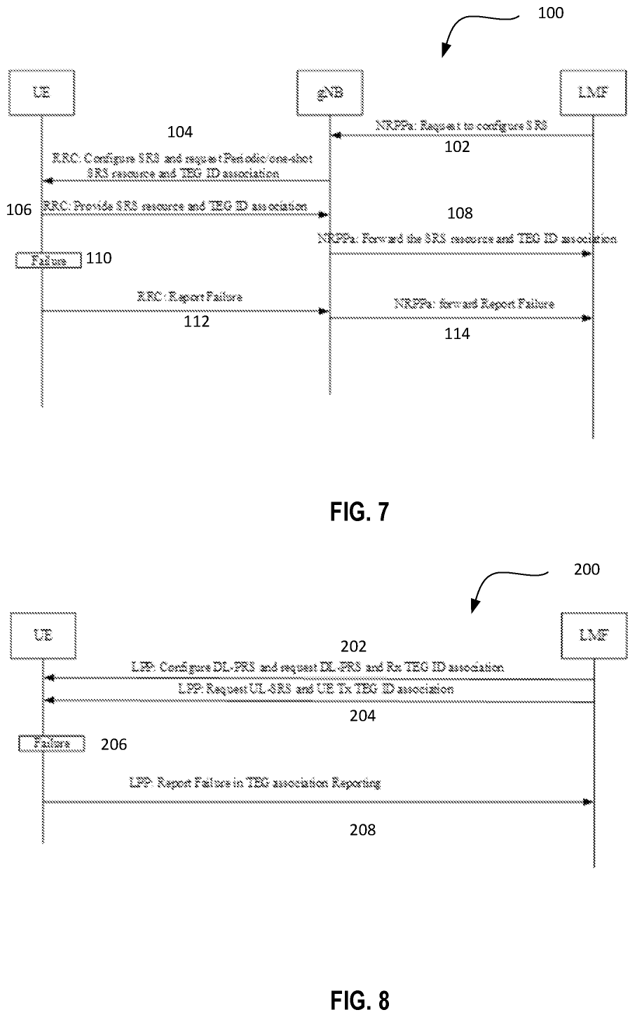

For example, FIG. 7 illustrates a sequence flow of a method 100 for signalling UE Tx TEG association with SRS (or the associated TEG ID) and for sending a failure indicator to the NW.

In step 102, the LMF sends a request to the gNB, over the NRPPa interface, to configure SRS.

In step 104, the gNB sends a RRC signal to the UE, the RRC signal indicating/comprising a configuration of SRS and a request (periodic or one shot) for SRS resource and TEG ID association (or the associated TEG ID).

In step 106, the UE provides, via RRC, the SRS resource and TED ID association (or the associated TEG ID) to the gNB (e.g. the UE is able to determine the association).

In step 108, the gNB forwards the SRS resource and TED ID association (or the associated TEG ID) to the LMF, via NRPPa, for example.

Later on, for another transmission, in step 110, the UE may detect/experience a failure to determine the association between the Tx TED and the SRS and thus it may fail to provide the TX TEG to SRS association (or the associated TEG ID). The reasons/causes for failing to determine the association are for example: change of state of the UE so that the UE cannot support the reference signal or the UE is performing in low battery. Other reasons are provided below.

In this case, in step 112, the UE reports an indication of the failure (to report the association/TEG ID) to the gNB, via RRC, for example.

In step 114, the gNB reports an indication of the failure (to report the association/TEG ID) to the LMF, via NRPPa, for example.

This method can be applicable for UL-TDOA as well.

Now, the steps of the method 100 will be described in more detail.

For example, more details are provided regarding step 112 where the UE provides an indication of failure of Tx TEG to SRS association reporting to the serving gNB, using RRC.

An example of Abstract Syntax Notation One (ASN.1) is shown below (for the UEPositioningAssistanceInfo IE), where the failure indication and possible causes of the failure are indicated in RRC, in bold text. As shown by the bold text in the ASN.1 below, one of the reasons of cause of failures, denoted by ‘state-transition’, may be when there is a RRC state transition to an RRC state where SRS may not be transmitted (e.g., transition to RRC_IDLE or transition to RRC_INACTIVE when the UE does not have the capability to support SRS transmission in RRC_INACTIVE). The reason denoted by ‘lowpowerstate’ is when a UE is performing Positioning operation in low power state and may not provide the UE Tx TEG to SRS association in order to reduce power consumption. The UE may also provide the reason for failure as ‘unknown’ in some embodiments. It should be noted however that the reasons for failure are not limited to the examples shown in the ASN.1 text below. Other reasons for failure may be as follows:
the reason for failure may be conveyed as a collision of SRS for positioning with physical uplink shared channel (PUSCH). For instance, if the SRS for the serving cell fully or partially collides with PUSCH, then the SRS for positioning may be dropped in the symbols where the collision occurs (see TS 38.214 V17.1.0 Clause 6.2.1). As a result, the SRS may not be transmitted in all the symbols that were allocated for SRS, and such information may be sent to the serving cell gNB as a reason for failure.
the reason for failure may be conveyed as a change in UE Tx TEGs due to time variation of the timing errors. For instance, in one case, at the time a SRS was transmitted, the timing error difference between this SRS transmission and a previous SRS transmission (e.g., a previous SRS transmitted from the same UE antenna panel) may have been within the margin used to define UE Tx TEGs. However, at the time when the SRS to TEG ID associations is to be sent to the serving gNB, the timing error difference corresponding to the same UE antenna panel may have exceeded the margin. Hence, the reason for ‘failureIndication-r17’ may be indicated as a change in UE Tx TEG from the time SRS was transmitted.

In some examples, the ‘failureIndication-r17’ field is only included in the UEPositioningAssistance Info message if the UE is not able to provide at least one UE Tx TEG to SRS association as part of the list ue-TxTEG-AssociationList-r17. If the UE is able to provide at least one UE Tx TEG to SRS association as part of the list ue-TxTEG-AssociationList-r17, then the ‘failureIndication-r17’ field is not included in the UEPositioningAssistanceInfo message.

ASN.1 example for the UEPositioningAssistanceInfo IE:
The UEPositioningAssistanceInfo message is used to provide positioning assistance information as requested by the Network.
   Signalling radio bearer: SRB1
   RLC-SAP: AM
   Logical channel: DCCH
   Direction: UE to Network

UEPositioningAssistanceInfo message

-- ASN1START
-- TAG-UEPOSITIONINGASSISTANCEINFO-START
UEPositioningAssistanceInfo-r17 ::= SEQUENCE {

| | |
|---|---|
| criticalExtensions | CHOICE { |
| uePositioningAssistanceInfo-r17 | UEPositioningAssistanceInfo-Ies-r17, |
| criticalExtensionsFuture | SEQUENCE { } |

}
}
UEPositioningAssistanceInfo-Ies-r17 ::= SEQUENCE {

| ue-TxTEG-AssociationList-r17 | UE-TxTEG-AssociationList-r17 | OPTIONAL, |
|---|---|---|
| failureIndication-r17 | ENUMERATED {state-transition, | |
| | lowpowerstate, | |
| | unknown, spare1} | OPTIONAL, |
| lateNonCriticalExtension | OCTET STRING | OPTIONAL, |
| nonCriticalExtension | SEQUENCE { } | OPTIONAL |

}
[...]
----------Editor Notes: RAN2 to decide on Event Driven Reporting, noChange, DeltaChange and
update based upon RAN1 agreement on SRS-ResourceSet and rest.--------
-- TAG-UEPOSITIONINGASSISTANCEINFO-STOP
-- ASN1STOP

UEPositioningAssistanceInfo field descriptions
failureIndication
Indicates the failure that UE in unable to provide the association

Now, more details are provided regarding step 114, where the gNB (e.g. gNB-CU) provides failure of Tx TEG to SRS association/TEG ID reporting to the LMF, using NRPPa, for example.

In one example, an indication of failure to report the UE Tx TEG indication from the gNB-CU, terminating the NRPPa protocol, is signalled over NRPPa positioning signalling, to the positioning server, i.e., LMF.

In one example, the report failure of the UE Tx TEG can indicate whether it is due to UE moving to RRC_INACTIVE state, being in low power state, or for unknown reasons or other reasons.

In one example, this failure indication can be signaled during the NRPPA POSITIONING INFORMATION FAILURE message, as shown in FIG. 12. For example, FIG. 12 illustrates the case of Positioning Information Exchange procedure: unsuccessful operation. An example from TS 38.455 v 17.0.0 is provided below with added text in bold:
If the Requested SRS Transmission Characteristics IE is included in the POSITIONING INFORMATION REQUEST message and the NG-RAN node is unable to configure any SRS transmissions for the UE, it shall respond with a POSITIONING INFORMATION FAILURE message. If a handover of the target UE has been triggered, the NG-RAN node shall send a POSITIONING INFORMATION FAILURE message with an appropriate cause value. If the UE TEG ID Information Request IE is included in the POSITIONING INFORMATION REQUEST message and the NG-RAN node is unable to report any UE Tx TEG association information for the UE, the NG-RAN node shall respond with a POSITIONING INFORMATION FAILURE message with appropriate cause value.

In one example, the gNB-CU responds/sends in the NRPPA POSITIONING INFORMATION FAILURE, re-using an existing Cause value from section 9.2.1 of TS 38.455 to indicate the inability and failure of the report (e.g., “Measurement Temporarily not Available” or “Requested Item not Supported on Time”)

In one example, the failure of UE Tx TEG association/TEG ID reporting is indicated in the NRPPa Error Indication message, with an appropriate cause value. This can happen in the case of periodic or a-periodic update from the gNB-CU to the LMF of the UE Tx TEG association.

In another example, a new cause value can be defined in section 9.2.1 of TS 38.455 to indicate in the NRPPA POSITIONING INFORMATION FAILURE or NRPPA ERROR INDICATION message the inability or failure reason of the gNB-CU to not report the UE Tx TEG information, e.g. “UE Tx TEG unavailable”, or “UE in low power state”, or “UE in RRC_INACTIVE state”.

The disclosure also provides methods for signalling indication of failure of UL-RTOA measurements (for UL-TDOA) when the LMF requests the TRP to measure the same SRS resource of a UE with different TRP Rx TEGs.

The disclosure also provides methods for signalling failure of gNB Rx-Tx time difference measurements (for multi-RTT) when the LMF requests the TRP to measure the same SRS resource of a UE with different TRP RxTx TEGs.

### F1 Positioning Embodiments for UE Tx TEG Report Failure

Referring again to FIG. 7, the gNB can have a split architecture, which comprises a gNB-DU and a gNB-CU. In step 112 of method 100, the gNB-DU receives the indication of failure to report the UE Tx TEG (e.g. SRS and UE Tx TEG association), from the UE. Then, the gNB-DU, hosting the lower layers (e.g. PHY), sends a message comprising the indication of failure to report the SRS and UE Tx TEG association, to the gNB-CU, which terminates the NRPPa protocol. The message is signaled over the FLAP positioning signaling, for example.

In one example, the failure to report the UE Tx TEG can indicate whether it is due to UE being in low power state, or for unknown reasons. Other reasons can be also indicated, as described earlier.

In one example, this failure indication can be signaled during the F1 POSITIONING INFORMATION FAILURE message, as illustrated in FIG. 10. For example, FIG. 10 illustrates the case of Positioning Information Exchange procedure: unsuccessful operation. An example from TS 38.473 v 17.0.0 is shown below, to which some text is added in bold:
If the Requested SRS Transmission Characteristics IE is included in the POSITIONING INFORMATION REQUEST message and the gNB-DU is unable to configure any SRS transmissions for the UE, the gNB-DU shall respond with a POSITIONING INFORMATION FAILURE message. If the UE TEG ID Information Request IE is included in the POSITIONING INFORMATION REQUEST message and the gNB-DU is unable to report any UE Tx TEG association information for the UE, the gNB-DU shall respond with a POSITIONING INFORMATION FAILURE message with appropriate cause value.

### 9.2.12.13 Positioning Information Request

This message is sent by the gNB-CU to indicate to the gNB-DU the need to configure the UE to transmit SRS signals for uplink positioning measurement.
Direction: gNB-CU→gNB-DU.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | reject |
| gNB-CU UE F1AP ID | M | 9.3.1.4 | YES | reject |
| gNB-DU UE F1AP ID | M | 9.3.1.5 | YES | reject |
| Requested SRS | O | 9.3.1.175 | YES | ignore |
| Transmission | | | | |
| Characteristics | | | | |
| UE TEG ID Information | O | ENUMERATED | YES | ignore |
| Request | | (true, . . .) | | |
| UE Reporting Information | O | 9.3.1.255 | YES | ignore |

### 9.2.12.15 Positioning Information Failure

This message is sent by the gNB-DU to indicate that no SRS transmissions could be configured for the UE for uplink positioning measurement.
Direction: gNB-DU→gNB-CU.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| Cause | M | | 9.3.1.2 | | YES | ignore |
| Criticality Diagnostics | O | | 9.3.1.3 | | YES | ignore |

In one example, the gNB-DU responds/sends in the F1 POSITIONING INFORMATION FAILURE, re-using an existing Cause value from section 9.3.1.2 of TS 38.473 an indication of the inability and failure of the report (e.g., “Measurement Temporarily not Available” or “Requested Item not Supported on Time”)

In one example, the failure of UE Tx TEG association reporting is indicated in the F1 Error Indication message, with an appropriate cause value. This can happen in the case of periodic or a-periodic update from the gNB-DU to gNB-CU on the UE Tx TEG association report.

In another example, a new cause value is defined in section 9.3.1.2 of TS 38.473 to indicate in the F1 POSITIONING INFORMATION FAILURE or ERROR INDICATION message the inability or failure reason of the gNB-DU to not report the UE Tx TEG information, e.g. “UE Tx TEG unavailable”, or “UE in low power state”.

FIG. 8 illustrates an exemplary sequence flow of a method 200 for signalling an indication of failure to report TEG association from a UE to a LMF, for Multi-RTT, for example. In this case, as shown in FIG. 8, the UE reports the failure directly to LMF via LPP, for example.

More specifically, method 200 comprises step 202 in which the LMF sends a signalling/message to the UE, the signalling comprising a configuration of DL-PRS and a request for a DL-PRS and Rx TEG ID association, via LPP for example.

In step 204 of method 200, the LMF also sends a request for UL-SRS and UE Tx TEG association, such as an association between the UL SRS and a UE Tx TEG ID. The request is sent via LPP, for example.

Method 200 also comprises step 206, in which the UE detects/experiences a failure to determine the association between the reference signal (DL-PRS or UL-SRS) and the TEG ID (Rx TEG ID or Tx TEG ID) and thus it fails to report the association. As such, in step 208, the UE sends a report to the LMF, the report comprising an indication of failure to report the reference signal and the TEG association, such as the DL-PRS and Rx TEG ID association or UL-SRS and Tx TEG ID association. The report is sent via LPP, for example.

For multi-RTT, the UE capability for supporting UE Tx-TEGs can be reported by the UE to the LMF. For multi-RTT, the association information can be reported along with the UE Rx/Tx measurements to the LMF.

Now, more details will be described regarding step 208 of method 200, in which the UE provides the indication of failure of Tx TEG to SRS association reporting to the LMF via LPP, for example.

The addition/indication for failure indication in LPP is provided below as an example shown in bold text in the ASN.1 of the NR-Multi-RTT-SignalMeasurementInformation. The UE uses tegTxReportingfailureIndication-r17 to indicate the reason for failure corresponding to SRS to UE Tx TEG association, and the UE uses failureCase-r17 to indicate the reason for failure corresponding to UE RxTx TEG reporting. One of the reasons for failure, denoted by ‘state-transition’, may be when there is a RRC state transition to an RRC state where a SRS may not be transmitted (e.g., transition to RRC_IDLE or transition to RRC_INACTIVE when the UE does not have the capability to support SRS transmission in RRC_INACTIVE). The reason denoted by ‘lowpowerstate’ is when a UE is performing Positioning operation in low power state, and may not provide the UE Tx TEG to SRS association or UE RxTx TEG reporting in order to reduce power consumption. The UE may also provide the reason for failure as ‘unknown’ in some embodiments. It should be noted however that the reasons for failure are not limited to the examples shown in bold text. Other reasons for failure may be as follows:
the reason for failure may be conveyed as a collision of SRS for positioning with physical uplink shared channel (PUSCH). For instance, if the SRS for the serving cell fully or partially collides with PUSCH, then the SRS for positioning may be dropped in the symbols where the collision occurs (see TS 38.214 V17.1.0 Clause 6.2.1). As a result, the SRS may not be transmitted in all the symbols that were allocated for SRS, and such information may be sent to the serving cell gNB as reason for failure.
the reason for failure may be conveyed as a change in UE Tx TEGs due to time variation of the timing errors. For instance, in one case, at the time a SRS was transmitted, the timing error difference between this SRS transmission and a previous SRS transmission (e.g., a previous SRS transmitted from the same UE antenna panel) may have been within the margin used to define UE Tx TEGs. However, at the time when the SRS to TEG ID associations are to be sent to the serving gNB, the timing error difference corresponding to the same UE antenna panel may have exceeded the margin. In such cases, the UE may indicate the reason for failure as a change in the UE Tx TEG from the time the SRS was transmitted.

In some examples, the ‘tegTxReportingfailureIndication-r17’ field is only reported if the UE is not able to provide at least one UE Tx TEG to SRS association. If the UE is able to provide at least one UE Tx TEG to SRS association, then the ‘tegTxReportingfailureIndication-r17’ field is not reported to the LMF.

As an example, the IE NR-Multi-RTT-SignalMeasurementInformation can be used by the target device to provide NR Multi-RTT measurements to the location server. The measurements can be provided as a list of TRPs, where the first TRP in the list is used as reference TRP.

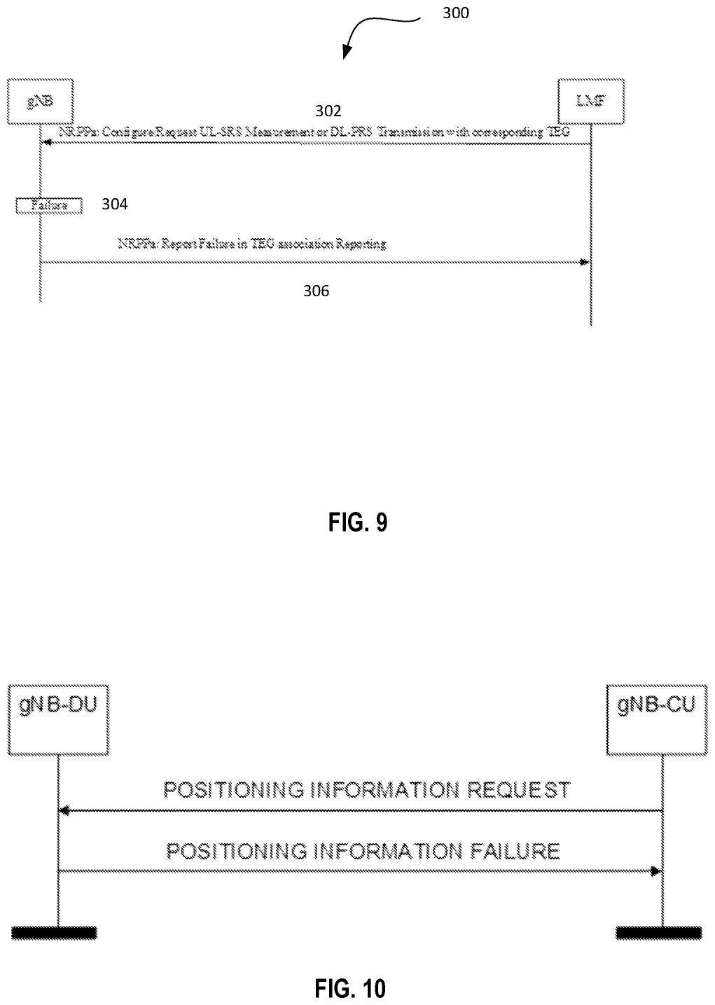

Similar to FIG. 8, FIG. 9 illustrates a sequence diagram of a method 300 for signalling an indication of failure of a reference signal and TEG association from a gNB (which can be considered as a TRP) to a LMF.

Method 300 comprises step 302, in which the LMF sends a message/signalling to the gNB (e.g. TRP), via NRPPa for example. The message may comprise a configuration/request of UL SRS measurement or DL-PRS transmission with corresponding TEG (Rx TEG or Tx TEG respectively).

In step 304, the gNB may experience/determine a failure to associate DL-PRS transmission with a corresponding TRP Tx TEG or to associate UL SRS measurement with a corresponding TRP Rx TEG. Some examples of the reasons for this failure are described above.

In step 306, the gNB reports an indication of the failure of DL-PRS/UL measurements and TEG association to the LMF, via NRPPa, for example.

### F1 Positioning Embodiments for TRP Rx or RxTx TEG Report Failure

The gNB of FIG. 9 can have a split architecture, which comprises a gNB-DU and a gNB-CU. In one example, the indication of failure to report the TRP Rx TEG or TRP RxTx is sent from the gNB-DU (hosting the lower layers (e.g. PHY)) to the gNB-CU (terminating the NRPPA protocol). The indication can be signaled over the F1AP positioning signaling, for example.

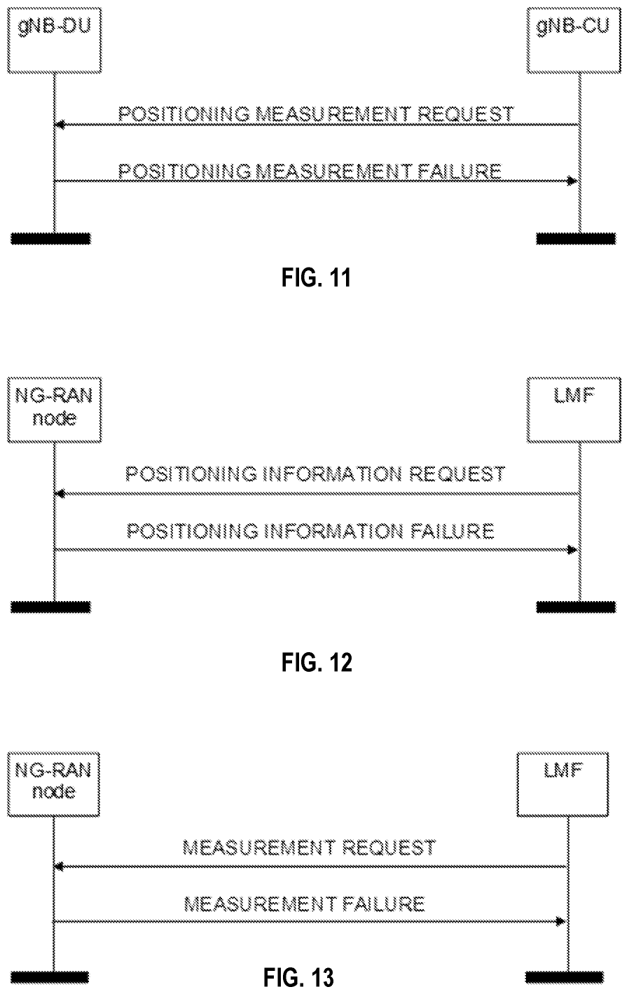

In one example, this failure indication is signaled during the F1 POSITIONING MEASUREMENT FAILURE message, as shown in FIG. 11. For example, FIG. 11 illustrates the case of Positioning Measurement procedure: unsuccessful operation. An example is provided below from TS 38.473 v17.0.0, in which some text is added in bold:
If the gNB-DU is unable to configure any of the requested positioning measurements for any of the TRPs in the TRP Measurement Request List IE of the POSITIONING MEASUREMENT REQUEST message, it shall respond with a POSITIONING MEASUREMENT FAILURE message. If the gNB-DU is unable to report any TRP Rx TEG or TRP RxTx TEG-ID information, it shall respond with a POSITIONING MEASUREMENT FAILURE message with appropriate cause value.

In one example, the gNB-DU responds/sends in the F1 POSITIONING MEASUREMENT FAILURE, re-using an existing Cause value from section 9.3.1.2 of TS 38.473 an indication of the inability and failure of the report (e.g., “Measurement Temporarily not Available” or “Requested Item not Supported on Time”).

In one example, the failure of TRP Rx TEG or TRP RxTx TEG reporting is indicated in the F1 Error Indication message, with an appropriate cause value.

In another example, a new cause value is defined in section 9.3.1.2 of TS 38.473 to indicate in the F1 POSITIONING MEASUREMENT FAILURE or ERROR INDICATION message the inability or failure reason of the gNB-DU to not report the TRP Rx TEG or TRP RxTx information, e.g. “TRP Rx TEG/TRP RxTx TEG unavailable.

### NRPPA Positioning Embodiments for TRP Rx or RxTx TEG Report Failure

With the split architecture of the gNB of FIG. 9, at step 306 of method 300, the indication of failure to report the TRP Rx TEG or TRP RxTx TEG is sent from the gNB-CU, terminating the NRPPA protocol, to the LMF. The indication can be signaled over the NRPPa signaling, for example.

In one example, this failure indication can be signaled during the MEASUREMENT FAILURE message, as shown in FIG. 13. For example, FIG. 13 illustrates the case of Measurement procedure: Unsuccessful operation. An example is provided below from TS 38.455 v17.0.0 with added text in bold:
If the NG-RAN node cannot configure any of the requested measurements for any of the TRPs in the TRP Measurement Request List IE of the MEASUREMENT REQUEST message, it shall respond with a MEASUREMENT FAILURE message with an appropriate cause value. If the NG-RAN node is unable to report any TRP Rx TEG or TRP RxTx TEG ID information, it shall respond with a MEASUREMENT FAILURE message with appropriate cause value.

In one example, the gNB-CU responds/sends in the MEASUREMENT FAILURE, re-using an existing Cause value from section 9.2.1 of TS 38.455 an indication of the inability and failure of the report (e.g., “Measurement Temporarily not Available” or “Requested Item not Supported on Time”).

In one example, the failure of TRP Rx TEG or TRP RxTx TEG reporting is indicated in the NRPPA Error Indication message, with an appropriate cause value.

In another example, a new cause value is defined in section 9.2.1 of TS 38.455 to indicate in the MEASUREMENT FAILURE or ERROR INDICATION message the inability or failure reason of the gNB to not report the TRP Rx TEG or TRP RxTx ID information, e.g. “TRP Rx TEG/TRP RxTx TEG unavailable.

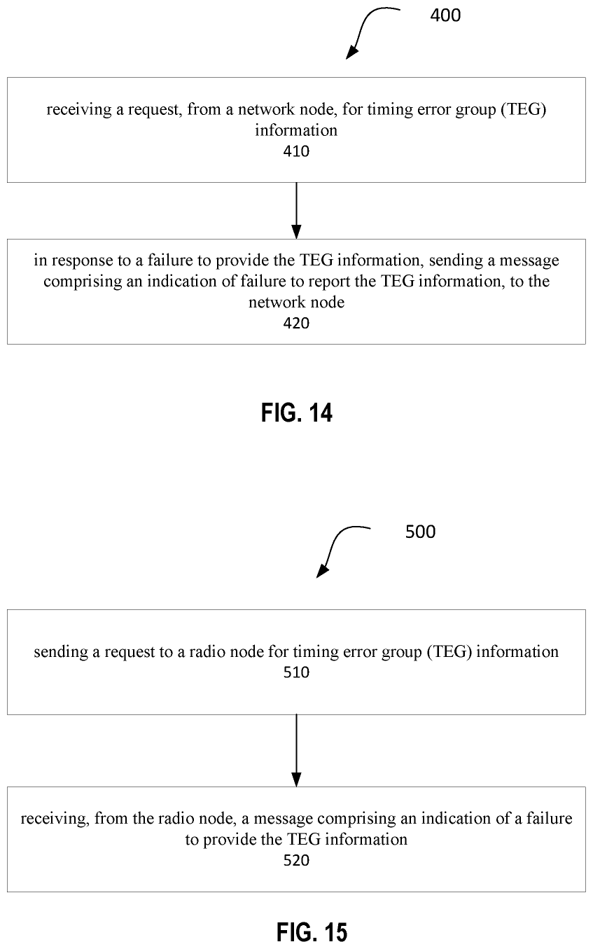

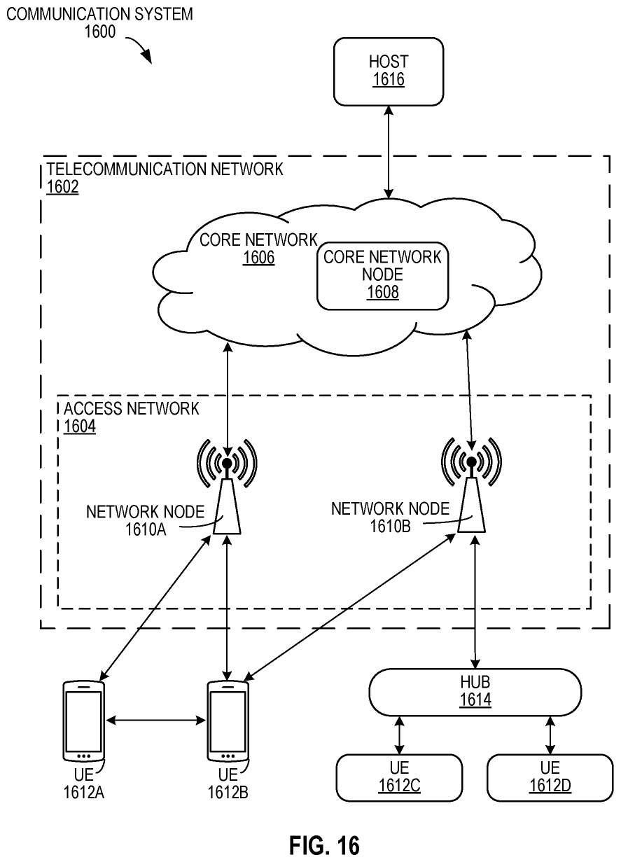

Now turning to FIG. 14, a flow chart of a method 400 for indicating a failure to report an association between a reference signal and a timing error group (TEG) will be described. The method can be performed by a radio node (e.g. UE 1612A or TRP/gNB (or network node 1610A) of FIG. 16). Method 400 may comprise:
Step 410: receiving a request, from a network node, for an association between a reference signal and a timing error group (TEG); and
Step 420: in response to a failure to determine the association, sending a message comprising an indication of failure to report the association, to the network node.

In an example, the message may further comprise an indication of a reason for the failure to determine the association or to report the association. Some reasons have been described earlier.

In a first case, the radio node can be a UE and the network node can be a gNB (which comprises a gNB-DU and a gNB-CU). In this case, the association between the reference signal and the TEG can be an association between a downlink reference signal and a receive TEG (e.g. UE Rx TEG) or an association between an uplink reference signal and a transmit TEG (e.g. UE Tx TEG). The request can be received via RRC from the network node (e.g. gNB). And the message can be sent via RRC to the network node (e.g. gNB).

In a second case, the radio node can a UE and the network node can be a Location management function (LMF). In this case, the request can be received via LTE Positioning Protocol (LPP) from the network node (e.g. LMF). And the message can be sent via LPP to the network node (e.g. LMF).

In a third case, the radio node can be a transmission reception point (TRP) and the network node can be a LMF. In this case, the request can be received via NRPPa from the network node (e.g. LMF). And the message can be sent via NRPPa to the network node (e.g. LMF).

### UE Behaviour

It should be clarified that a UE may still continue to transmit UL SRS even when it is unable to report the (periodic) TEG association for any reason. The UE should be able to handle the failure, i.e. provide a failure report on the TEG association report and continue transmitting UL-SRS or performing DL-PRS measurements.

In an embodiment, if the positioning Quality of Service (QOS) for high accuracy is a must, then, based upon receiving such failure report the positioning computing entity such as the LPP layer in a LMF and the UE or any location consuming entity, such as location services client (LCS client), may decide whether to continue or abandon/abort the positioning procedure. It may be very critical to obtain the TEG report to achieve high accuracy and thus for cases where high accuracy may not be achieved, the positioning computing entity or location consuming entity such as the LCS client may decide to abandon/abort the procedure.

As a note, a LCS Client is an entity that interacts with a Gateway Mobile Location Centre (GMLC) for the purpose of obtaining location information for one or more UEs. The LCS Client may reside in the UE.

Further, the standard specification of 3GPP TS 38.455 may be changed to “Add failure description for the NRPPA POSITIONING INFORMATION FAILURE message when NG-RAN fails to report the UE Tx TEG association”.

This change is due to the fact that the current procedural text specifies the behaviour of the NG-RAN node when it is unable to configure any SRS transmissions for the UE, by responding with a POSITIONING INFORMATION FAILURE message. A description of failure handling is also needed when the NG-RAN node is unable to report any UE Tx TEG association information when the LMF has requested so.

FIG. 15 illustrates a flow chart of a method 500 for requesting a report of an association between a reference signal and a timing error group (TEG). The method may be implemented in a network node, such as 1610A or a core network node 1608 of FIG. 16. Method 500 may comprise:
Step 510: sending a request to a radio node for an association between a reference signal and a timing error group (TEG); and
Step 520: receiving, from the radio node, a message comprising an indication of a failure to associate the reference signal with the TEG.

In an example, the message may further comprise an indication of a reason for the failure to determine the association or to report the association. Some reasons have been described earlier.

In a first case, the radio node can be a UE and the network node can be a gNB. In this case, the request can be sent via RRC to the UE and the message is received via RRC, from the UE. In another example, the gNB can forward/send the message comprising the indication of failure to a core network node (e.g. LMF), via NRPPa. The gNB can receive, from the core network node (e.g. LMF) a request to configure the radio node with the reference signal, via NRPPa. Furthermore, the gNB can have a gNB-DU and a gNB-CU. Then, the gNB-DU can send the message comprising the indication of the failure to the gNB-CU via F1. This message can be a positioning information failure message or an error indication message.

In a second case, the radio node can be a UE and the network node can be a LMF. In this case, the request can be sent via a LTE Positioning Protocol (LPP) from the network node (e.g. LMF) to the UE. And the message can be received via LPP from the UE.

In a third case, the radio node can be a TRP and the network node can be a LMF. In this case, the request can be sent via NRPPa from the network node (e.g. LMF). And the message can be received via NRPPa at the network node (e.g. LMF).

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3GPP access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602 and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

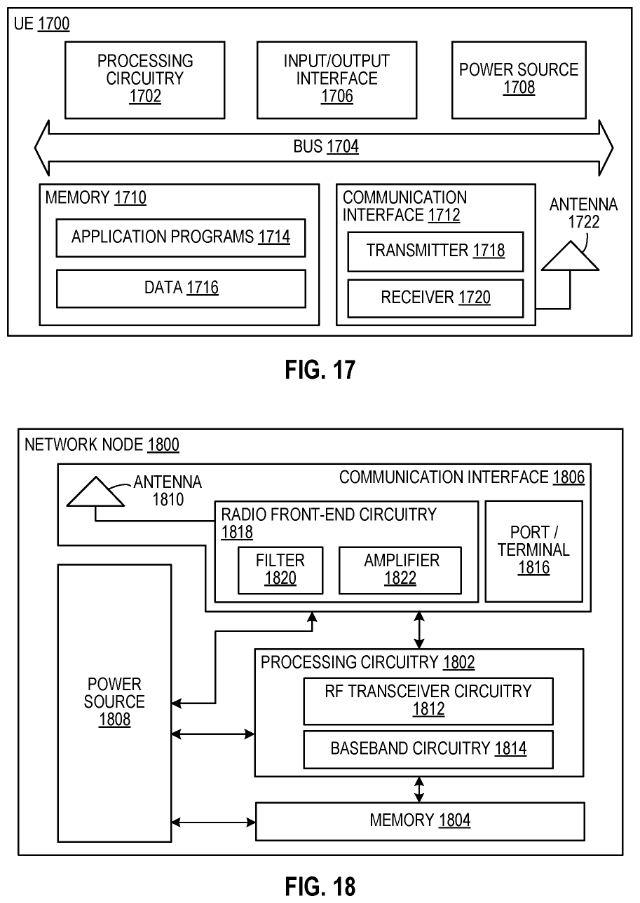

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs). For example, the processing circuitry 1702 can be configured to perform any of the steps/operations/blocks of method 400 of FIG. 14, for example.

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, etc. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, NBs, evolved NBs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality. For example, the processing circuitry 1802 is configured to perform any actions/operations/blocks of method 500 of FIG. 15 when the network node is a core network node or method 400 of FIG. 14 when the network node is a gNB/TRP.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

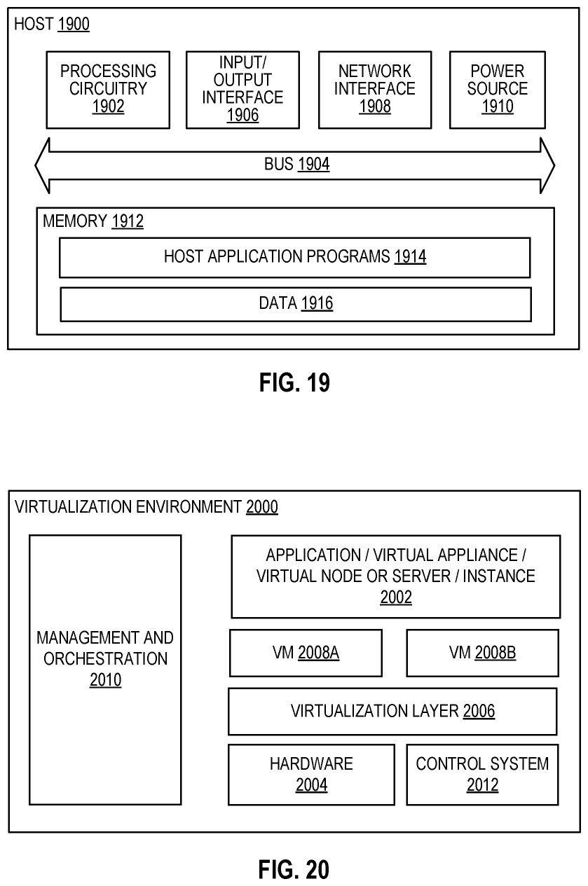

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

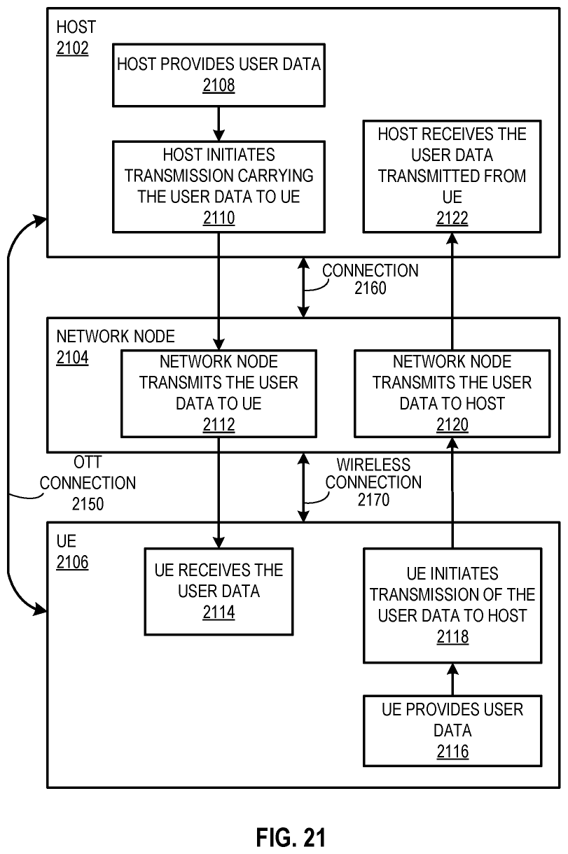

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may improve e.g., the data rate, latency, power consumption and thereby provide benefits such as e.g., reduced user waiting time, better responsiveness, extended battery lifetime.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description, which is defined solely by the appended claims.

1. A method performed by a radio node, the method comprising:
receiving a periodic request, from a network node, for timing error group (TEG) information; and
in response to a failure to provide the TEG information, sending a message comprising an indication of failure to report the TEG information, to the network node.

2. The method of claim 1, wherein the message further comprises an indication of a reason for the failure to report the TEG information.

3. The method of claim 1, wherein the TEG information is a User Equipment (UE) TEG information.

4. The method of claim 1, wherein the TEG information is associated with one or more reference signals.

5. The method of claim 4, wherein the association between the one or more reference signals and the TEG information comprises an association between an uplink reference signal and a receive (Rx) TEG.

6. (canceled)

7. The method of claim 1, wherein the request is received via NRPPa or F1AP signalling from the network node.

8. The method of claim 1, wherein the message is sent via NRPPa or F1AP signalling to the network node.

9. The method of claim 1, wherein the request is a Positioning Information Request.

10. The method of claim 1, wherein the message is a Positioning Information Failure.

11. (canceled)

12. (canceled)

13. (canceled)

14. (canceled)

15. (canceled)

16. A method performed by a network node, the method comprising:
sending a periodic request to a radio node for timing error group (TEG) information; and
receiving, from the radio node, a message comprising an indication of a failure to provide the TEG information.

17. The method of claim 16, wherein the message further comprises an indication of a reason for the failure to report the TEG information.

18. The method of claim 16, wherein the TEG information is a User Equipment (UE) TEG information.

19. The method of claim 16, wherein the TEG information is associated with one or more reference signals.

20. The method of claim 19, wherein the association between the one or more reference signals and the TEG information comprises an association between an uplink reference signal and a receive (Rx) TEG.

21. (canceled)

22. The method of claim 16, wherein the request is sent via NRPPa or F1AP signalling from the network node.

23. The method of 16, wherein the message is received via NRPPa or F1AP signalling by the network node.

24. The method of claim 16, wherein the request is a Positioning Information Request.

25. The method of claim 16, wherein the message is a Positioning Information Failure.

26. (canceled)

27. (canceled)

28. (canceled)

29. (canceled)

30. (canceled)

31. A radio node comprising:
a communication interface; and
processing circuitry associated with the communication interface, the processing circuitry configured to cause the radio node to:
receive a periodic request, from a network node, for timing error group (TEG) information; and
in response to a failure to provide the TEG information, send a message comprising an indication of failure to report the TEG information, to the network node.

32. (canceled)

33. (canceled)
